(19) United States
(12) Patent Application Publication
(10) Pub. No.: US 2004/0026152 A1
(43) Pub. Date: Feb. 12, 2004

(54) Transmission systems and apparatus incorporating same

(76) Inventor: Keith William Dowling, New South Wales (AU)

Correspondence Address: Don W. Bulson, Renner Otto Boisselle & Sklar, 1621 Euclid Avenue, 19th Floor, Cleveland, OH, 44115, US

(21) Appl. No.: 10/380,958

(22) PCT Filed: Sep. 20, 2001
(86) PCT No.: PCT/AU01/01184

(30) Foreign Application Priority Data
Sep. 20, 2000 (AU) PR 0247
Oct. 27, 2000 (AU) PR 1096

(51) Int. Cl. B60K 17/00

(52) U.S. Cl. 180/305

(57) ABSTRACT

Hydraulically driven apparatus where the rotation of a ground contact wheel (3) automatically rotates a second device requiring drive (5) via a circuit (15, 16) and hydraulic motors (4,6) attached to the wheel (3) and second device (5), respectevely. The apparatus can be used in many applications including in one embodiment used as a transmission system to drive a rotary broom (5) of a sweeping apparatus.

### TECHNICAL FIELD

This invention relates to rotary transmission systems and has particular relevance to apparatus where a rotating device is driven indirectly by ground wheel(s) of a vehicle or apparatus.

### BACKGROUND ART

There are many examples of devices where the motion of the ground wheel(s) of the device provides a motive force for driving a rotatable member associated therewith.

Mowers, harvesting and sweeping devices are all examples of such.

In all cases the rotation of a ground wheel(s) is translated to the rotatable member by a mechanical drive system which may include belts, gears, chains or a combination of these.

This type of mechanical drive can be expensive and may require regular maintenance, particularly if the apparatus is used in a dusty and dirty environment.

It is an object of the present invention to provide an improved apparatus where the motion of a ground wheel or wheels is translated into the rotation of a rotatable member associated therewith.

Further objects and advantages of the present invention will become apparent from the ensuing description which is given by way of example.

### DISCLOSURE OF INVENTION

According to a first aspect of the present invention there is provided a transmission system for translating the rotation of a first wheel of a carriage to a second wheel of the carriage remote from the first wheel the system comprising a ground wheel having a first hydraulic motor associated with the ground wheel in such a manner that the motor is driven on rotation of the ground wheel, a second wheel having an associated second hydraulic motor, and a closed circuit between the hydraulic motors, the arrangement and construction being such that when the ground wheel is rotated as a result of frictional contact with and movement over a ground surface a corresponding rotation of the second wheel takes place as hydraulic fluid is circulated within the hydraulic circuit and between the hydraulic motors.

The first wheel can be a castor wheel and the second wheel a rotatable implement.

The castor wheel can be mounted with respect to the carriage by a hydraulic coupling which allows the castor wheel to swivel on a vertical axis and additionally provides means by which the hydraulic fluids within the closed circuit can be pumped to and from the driven motor.

According to a further aspect of the present invention there is provided a sweeper device comprising a body a ground wheel supported by the body, a rotatable broom journalled with respect to the body, means for collecting swept materials within the confines of the body and a transmission means as aforesaid for driving the rotatable broom as the ground wheel rotates.

Coupling means can be provided for connection of the body of the sweeper to a motorised vehicle.

The body can be provided with means for receiving the forks of a forklift for the purpose of transportation and operation of the sweeper.

The body can be provided with a collecting plate at the base thereof which can be pivoted open to release swept materials.

The body can be provided with a leveling castor wheel or wheels in a position forward of the second wheel.

The capacities of the first and second motors can vary to provide hydraulic gearing ratios.

The motors are associated with hub axles of the first and second wheels.

### BRIEF DESCRIPTION OF THE DRAWINGS

Aspects of the present invention will now be described with reference to the accompanying drawings in which;

FIGS. 1 to 4 are plan, front, side and rear views respectively of a sweeping apparatus incorporating the present invention, and

FIG. 5 is an outline drawing of major components of the apparatus of FIG. 1, and

FIG. 6 is a schematic drawing of the hydraulic components and driver and driven wheels of the apparatus of FIG. 1, and

FIGS. 7 and 7a are circuit diagrams of a reversing valve circuit for the apparatus of the present invention, and

FIG. 8 is a sectional drawing of a hydraulic coupling for the apparatus of FIG. 1, and

FIGS. 9 and 9a are sectional and side views of a driver wheel for the apparatus of FIG. 1.

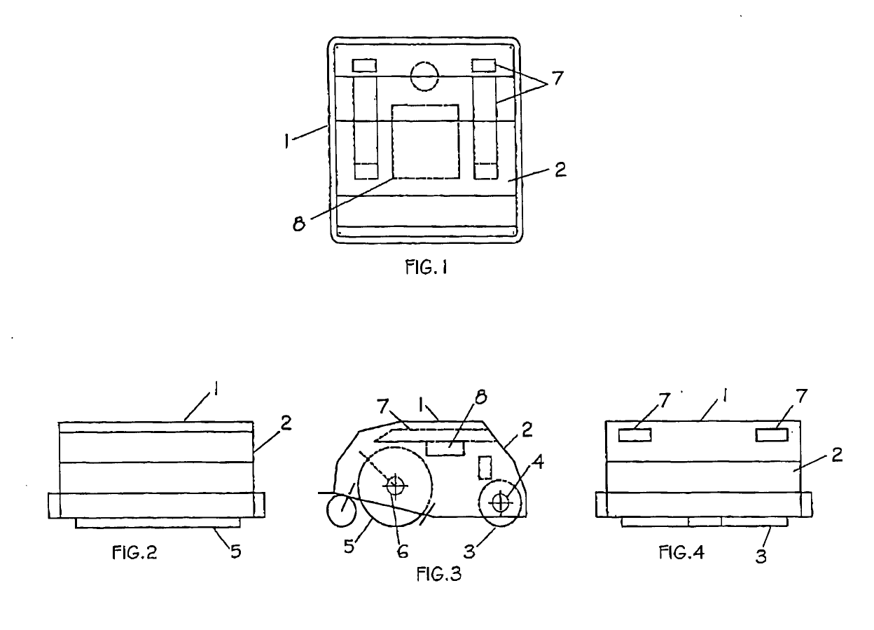

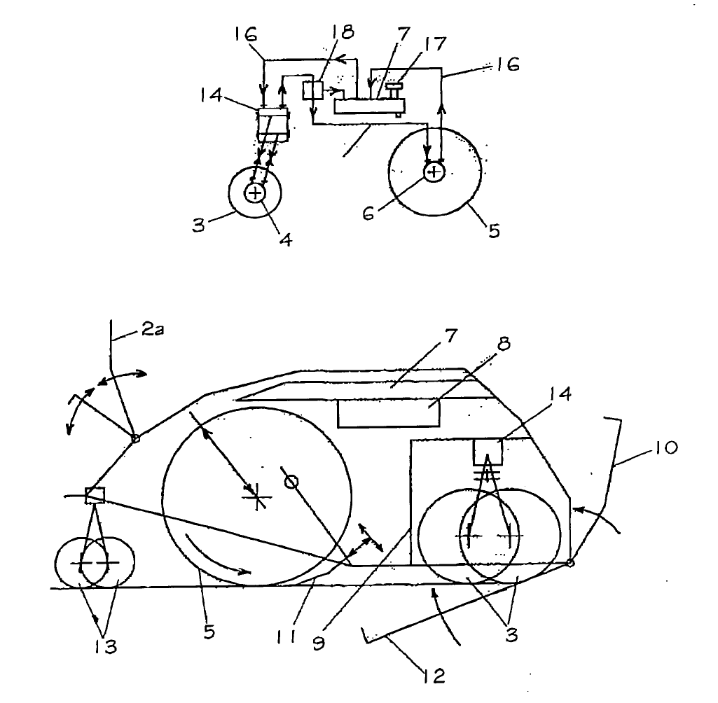

With respect to FIGS. 1 to 4 of the drawings in one embodiment of the present invention there is provided a sweeping apparatus generally indicated by arrow 1 comprising a body 2, a ground wheel 3 supported by the body, a first hydraulic motor 4 connected to the ground wheel which is adapted to be driven as the wheel 3 rotates and a second wheel or device 5 adapted to be driven by a second hydraulic motor 6 communicable with the first hydraulic motor and adapted to drive the second wheel or device 5 as the ground wheel 3 rotates.

The motors 4 and 6 are general purpose hydraulic motors, a suitable motor type being sold under the name EATON by Berendsen Fluid Power of Queensland, Australia.

In sweeping device illustrated the second wheel 5 is a rotatable broom.

The interiors of the body 2 incorporate linking hydraulic circuitry between the motors associated with the first and second wheels.

Elongate slots 7 provide means by which the device can be engaged by the forks of a forklift for the purpose of lifting the apparatus and moving it over a ground surface with the wheel 3 in frictional contact with the surface.

The body 2 mounts a storage tank 8 for hydraulic fluids in a closed circuit with the tank and the hydraulic motors 4 and 6.

The body 2 can be provided with flaps and doors as illustrated by FIG. 5.

A top front door 2a provides access into the interiors of the body 2 adjacent the broom 5.

The ground contact wheel 3 is housed within a turret 9, access to which can be facilitated by a hinged rear door 10.

A ramp 11 adjacent the broom 5 collects matter swept by the broom and deposits it on a hinged collection plate 12 at the base of the body 2.

A front castor wheel 13 provides leveling stability for the body 2.

With respect to FIG. 6 of the drawings the integrated hydraulic circuit between the first and second wheels 3 and 5 includes a hydraulic coupling generally indicated by arrow 14 and a storage tank 8.

The hydraulic motors 4 and 6 are communicable via closed circuitry, which includes pressure and suction lines 15 and 16 respectively,

Suction lines 16 are connected between the storage tank 8 and each of the motors 4 and 6.

The suction line 16 from the tank 7 to the first motor 4 passes through the hydraulic coupling 14.

The hydraulic circuit can include a venting filter 17 and a pressure relief valve 18.

A suitable relief valve is sold in Australia by Berendsen Fluid Power of Queensland, Australia under the code RV10-22.

The path arrows of FIG. 6 Indicate fluid flow directions in the hydraulic circuit, which occur when the ground wheel 3 is rotated by contact with the ground and movement across a surface in any direction.

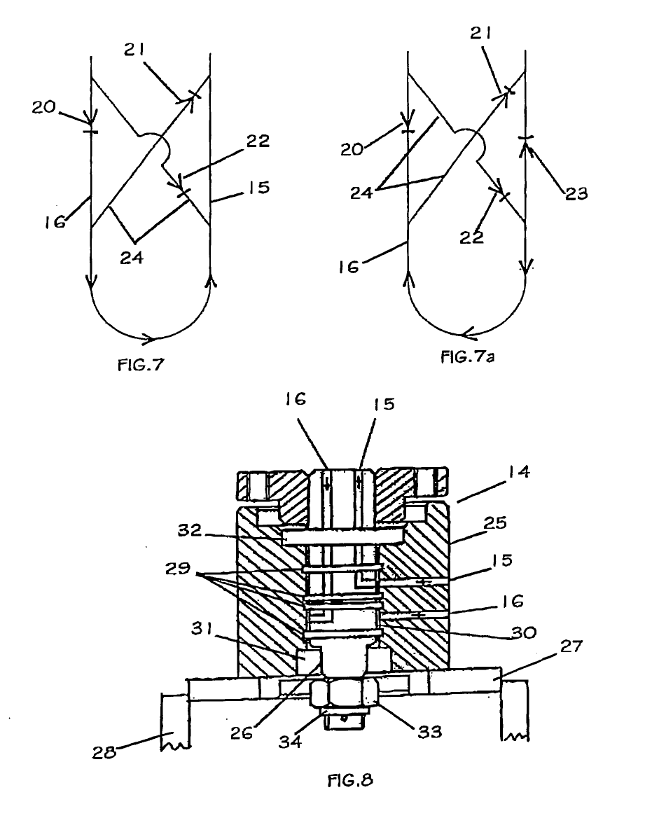

In FIGS. 7 and 7a of the drawings the hydraulic coupling 14 includes a reversing valve circuit containing check valves 20, 21 22 and 23.

With respect to FIG. 7 when the castor wheel is driven in an anti-clockwise (forward) direction valve 20 in the suction line 16 will open as will valve 23 in the pressure line 15 and the valves 21, 22 in by-pass lines 24 will close.

By contrast and as illustrated by FIG. 7a when the castor wheel is driven in a clockwise (reverse) direction the valves 20 and 23 in the suction and pressure lines 16 and 15 will close and the valves 21 and 22 in the pass lines 24 will open.

Thus no matter what direction the castor wheel is rotated a positive pressure flow of fluid is fed to the pump 6.

With respect to FIG. 8 the hydraulic rotary coupling 14 comprises an outer hub 25 and an inner shaft 26 journalled to the hub.

The inner hub 25 has pressure and suction lines 15 and 16, as does the shaft 26.

A mounting flange 27 provides means by which the coupling can be fixed to the wheels of the apparatus and a further flange 28 provides means by which the coupling can be fixed to a castor wheel.

Hydraulic seals 29 isolate a common chamber 30 into which the respective pressure and suction lines 15 and 16 are fed.

Roller bearings 31, 32 allow the castor wheel body to rotate with respect to the outer hub 25.

A nut 33 and lock washer 34 are used to secure the flange 27 to the shaft 26.

The motors 4 and 6 (some times referred to as hydraulic positive displacement pumps) provide a relatively maintenance free transmission drive system and will provide sufficient power and rotational speeds to suit selected applications.

The motors 4 and 6 can be selected to provide significant hydraulic gearing ratios.

A larger capacity motor 4 of say 40 cc capacity can be associated with the castor wheel and incorporated in a closed circuit with a smaller capacity motor 6 of say 20 cc to provide a hydraulic gearing ratio.

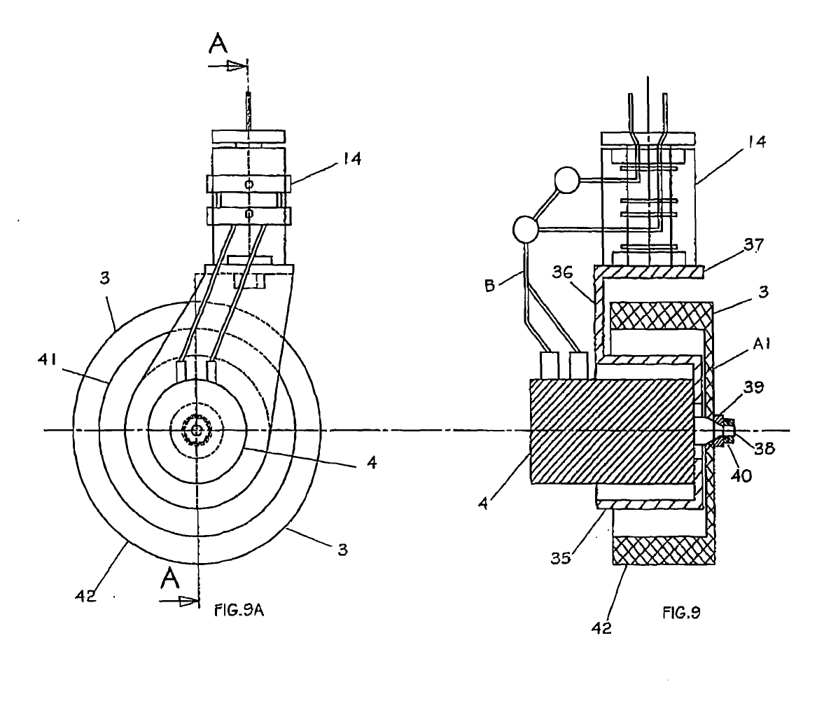

With respect to FIGS. 9 and 9a of the drawings the ground wheel 3 is supported by the body via the coupling 14 by a motor mounting hub generally indicated by arrow 35 which comprises a box-section member 36 extending from a cantilevered support 37 connected to the coupling.

The output shaft 38 of the motor 4 is fixed to the wheel 3 by a taper drive 39 and a retaining nut 40.

The wheel 3 comprises a metal rim 41 and a rubber tyre 42.

The motor 4 is hydraulically connected back to the hydraulic coupling as previously described and then to the motor 6.

As the wheel rotates the motor 4 Is activated as previously described.

A similar motor to wheel attachment and detail is made to the broom wheel 6.

Whilst transmission system of the present invention is described in relation to a sweeper device described it is to be appreciated that it may be incorporated other apparatus in analogous situations, e.g. in harvesting apparatus, mowers or the like.

Aspects of the present invention have been described by way of example only and it will be appreciated that modifications and additions thereto may be made without departing from the scope thereof, as defined in the appended claims.

1. A transmission system for translating the rotation of a first wheel of a carriage to a second wheel of the carriage remote from the first wheel the system comprising a ground wheel having a first hydraulic motor associated with the ground wheel in such a manner that the motor is driven on rotation of the ground wheel, a second wheel having an associated second hydraulic motor, and a closed circuit between the hydraulic motors, the arrangement and construction being such that when the ground wheel is rotated as a result of frictional contact with and movement over a ground surface a corresponding rotation of the second wheel takes place as hydraulic fluid is circulated within the hydraulic circuit and between the hydraulic motors.

2. A transmission system as claimed in claim 1 wherein the first wheel is a castor wheel and the second wheel is a rotatable implement.

3. A transmission system as claimed in claim 1 wherein the castor wheel is mounted with respect to the carriage by a hydraulic coupling which allows the castor wheel to swivel on a vertical axis and additionally provides means by which the hydraulic fluids within the closed circuit can be pumped to and from the driven motor.

4. A sweeper device comprising a body a ground wheel supported by the body, a rotatable broom journalled with respect to the body, means for collecting swept materials within the confines of the body and a transmission means as claimed in claim 1 for driving the rotatable broom of the ground wheel rotates.

5. A sweeper device as claimed in claim 4 including coupling means for connection of the body of the sweeper to a motorised vehicle.

6. A sweeper device as claimed in claim 4 wherein the body is provided with means for receiving the forks of a forklift for the purpose of transportation and operation of the sweeper.

7. A sweeper device as claimed in claim 4 wherein the body is provided with a coil cting plate at the base thereof which can be pivoted open to release swept materials.

8. A sweeper device as claimed in claim 4 wherein the body is provided with a leveling castor wheel or wheels in a position forward of the rotatable broom.

9. A sweeper device as claimed in claim 4 wherein the capacities of the first and second motors vary to provide hydraulic gearing ratios.

10. A sweeper device as claimed in claim 4 wherein the motors are associated with hub axles of the first and second wheels.
